(19) United States
(12) Patent Application Publication
(10) Pub. No.: US 2011/0243464 A1
(43) Pub. Date: Oct. 6, 2011

(54) IMAGE PROCESSING CONTROL DEVICE AND METHOD

(75) Inventors: Keisuke Chida, Tokyo (JP); Masashi Uchida, Tokyo (JP)

(73) Assignee: Sony Corporation, Tokyo (JP)

(21) Appl. No.: 13/053,598

(22) Filed: Mar. 22, 2011

(30) Foreign Application Priority Data
Mar. 31, 2010 (JP) 2010-080523

(51) Int. Cl. G06K 9/46

(52) U.S. Cl. 382/232

(57) ABSTRACT

An image processing control device includes an adjacent pixel difference absolute value phase-based total value calculation unit configured to calculate adjacent pixel difference absolute value phase-based total values obtained by summing adjacent pixel difference absolute values, which are absolute values of differences in pixel value between adjacent pixels of an image subjected to predetermined image processing, with respect to all pixels of the image, every phase representing a location between the pixels of an encoding block when the image is encoded, a maximum boundary phase specifying unit configured to specify a maximum boundary phase which is a phase of a maximum value among the adjacent pixel difference absolute value phase-based total values calculated every phase, and a control unit configured to control the image processing so as to reduce encoding block distortion generated between pixels of the specified maximum boundary phase.

### BACKGROUND OF THE INVENTION

1. Field of the Invention

The present invention relates to an image processing control device and method and, more particularly, to an image processing control device and method capable of improving precision of encoding block distortion reduction.

2. Description of the Related Art

In the related art, a method of reducing encoding block distortion compared with encoded data obtained by encoding image data in block units is considered (for example, see Japanese Patent No. 3700195).

For encoding block distortion reduction, a distortion amount is calculated. For example, there is a method of calculating a distortion amount in encoding block units. In addition, as shown in FIG. 1, there is a method of calculating a distortion amount from a scale of difference in pixel value between block boundaries and a difference in pixel value of a peripheral pixel thereof. In the example of FIG. 1, a difference between a pixel value within a predetermined range denoted by a rectangle 11 and a pixel value of an adjacent pixel is obtained so as to measure the distortion amount.

### SUMMARY OF THE INVENTION

However, in the method of the related art, if the distortion amount of encoding block distortion is calculated using the pixel value of a local range, for example, in FIG. 2, as denoted by an ellipse 12, if an original edge of an input image is present in the vicinity of a block boundary, it is difficult to distinguish between the edge and the block boundary. By the erroneous detection of such an edge, distortion amount calculation precision may be reduced.

If information about the peripheral pixels is used in order to increase the distortion amount calculation precision, a computation amount (load) or a necessary memory amount may be increased.

In addition, since encoding block distortion occurs in the vicinity of a block boundary, it is necessary to accurately detect the encoding block boundary. However, in general, for processing load reduction, on the assumption that encoding blocks each having a predetermined size are arranged in parallel from a screen end, a method of estimating the position of an encoding block boundary using the block size is employed.

However, for example, like Picture-In-Picture, if a small image is embedded into a large image, the position of the encoding block of the embedded small image is deviated from the position of the encoding block of the large image. That is, the position of the encoding block boundary of the small image is not the position which is an integral multiple of the block size from the screen end. To this end, in the method of estimating the position of the encoding block boundary by the block size, the position of the block boundary may not be accurately specified.

In addition, if an input image is an image obtained by scaling up or down a signal encoded or decoded to a size of an image different from the input image, since an encoding block width is changed to an original width, it is difficult to detect the encoding block boundary.

A method of holding information such as an encoding block width as data in addition to image information upon encoding and performing detection using the information at an encoding detection processing side is considered. However, a device for reducing encoding distortion may not acquire data other than image information. For example, if decoding is performed by a signal processing of a video player and encoding distortion detection is performed by a signal processing in a television connected to the video player through a video cable, the television may not acquire data other than image information from the video player.

It is desirable to improve encoding block distortion reduction precision.

According to an embodiment of the present invention, there is provided an image processing control device including: an adjacent pixel difference absolute value phase-based total value calculation unit configured to calculate adjacent pixel difference absolute value phase-based total values obtained by summing adjacent pixel difference absolute values, which are absolute values of differences in pixel value between adjacent pixels of an image subjected to predetermined image processing, with respect to between all the pixels of the image, every phase representing a location between the pixels of an encoding block when the image is encoded; a maximum boundary phase specifying unit configured to specify a maximum boundary phase which is a phase of a maximum value among the adjacent pixel difference absolute value phase-based total values calculated every phase by the adjacent pixel difference absolute value phase-based total value calculation unit; and a control unit configured to control the image processing so as to reduce encoding block distortion generated between pixels of the maximum boundary phase specified by the maximum boundary phase specifying unit.

The image processing control device may further include a maximum value specifying unit configured to specify a maximum value among the adjacent pixel difference absolute value phase-based total values calculated every phase by the adjacent pixel difference absolute value phase-based total value calculation unit, an average value calculation unit configured to calculate an average value of the adjacent pixel difference absolute value phase-based total values calculated every phase by the adjacent pixel difference absolute value phase-based total value calculation unit, and an encoding block distortion amount calculation unit configured to calculate an encoding block distortion amount of the phase by subtracting the average value calculated by the average value calculation unit from the maximum value specified by the maximum value specifying unit, and the control unit may control the image processing so as to reduce the encoding block distortion generated between the pixels of the maximum boundary phase specified by the maximum boundary phase specifying unit to a degree according to the encoding block distortion amount calculated by the encoding block distortion amount calculation unit.

The image processing control device may further include a normalization encoding block distortion amount calculation unit configured to normalize the encoding block distortion amount calculated by the encoding block distortion amount calculation unit by the average value calculated with the average value calculation unit and to calculate a normalization encoding block distortion amount of the phase, and the control unit may control the image processing so as to reduce the encoding block distortion generated between the pixels of the maximum boundary phase specified by the maximum boundary phase specifying unit to a degree according to the normalization encoding block distortion amount calculated by the normalization encoding block distortion amount calculation unit and the encoding block distortion amount calculated by the encoding block distortion amount calculation unit.

The control unit may decrease a degree of reducing the encoding block distortion generated between the pixels of the maximum boundary phase specified by the maximum boundary phase specifying unit, if the normalization encoding block distortion amount calculated by the normalization encoding block distortion calculation unit is small and the encoding block distortion amount calculated by the encoding block distortion amount calculation unit is large.

The control unit may increase a degree of reducing the encoding block distortion generated between the pixels of the maximum boundary phase specified by the maximum boundary phase specifying unit, if the normalization encoding block distortion amount calculated by the normalization encoding block distortion calculation unit is large and the encoding block distortion amount calculated by the encoding block distortion amount calculation unit is small.

The adjacent pixel difference absolute value phase-based total value calculation unit may calculate the adjacent pixel difference absolute value phase-based total values with respect to neighboring pixels in a horizontal direction of the image.

The adjacent pixel difference absolute value phase-based total value calculation unit may calculate the adjacent pixel difference absolute value phase-based total values with respect to neighboring pixels in a vertical direction of the image.

The image processing device may further include an image size change unit configured to change an image size of an image, the image size of which is changed after encoding, and the adjacent pixel difference absolute value phase-based total value calculation unit may calculate the adjacent pixel difference absolute value phase-based total value of the image, the image size of which is changed by the image size change unit.

According to an embodiment of the present invention, there is provided at an adjacent pixel difference absolute value phase-based total value calculation unit of the image processing control device, calculating adjacent pixel difference absolute value phase-based total values obtained by summing adjacent pixel difference absolute values, which are absolute values of differences in pixel value between adjacent pixels of an image subjected to predetermined image processing, with respect to between all the pixels of the image, every phase representing a location between the pixels of an encoding block when the image is encoded; at a maximum boundary phase specifying unit of the image processing control device, specifying a maximum boundary phase which is a phase of a maximum value among the adjacent pixel difference absolute value phase-based total values calculated every phase; and at a control unit of the image processing control device, controlling the image processing so as to reduce encoding block distortion generated between pixels of the specified maximum boundary phase.

In the embodiment of the present invention, the adjacent pixel difference absolute value phase-based total values obtained by summing adjacent pixel difference absolute values, which are absolute values of differences in pixel value between adjacent pixels of an image subjected to predetermined image processing, are calculated with respect to all pixels of the image every phase representing a location between the pixels of an encoding block when the image is encoded, a maximum boundary phase which is a phase of a maximum value among the adjacent pixel difference absolute value phase-based total values calculated every phase is specified, and the image processing is controlled so as to reduce encoding block distortion generated between pixels of the specified maximum boundary phase.

According to the present invention, it is possible to control image processing. In particular, it is possible to improve encoding block distortion reduction precision.

### BRIEF DESCRIPTION OF THE DRAWINGS

FIG. 1 is a diagram illustrating a method of detecting an encoding block distortion amount of the related art;

FIG. 2 is a diagram illustrating a method of detecting an encoding block distortion amount of the related art;

FIG. 3 is a diagram illustrating the outline of a method of detecting a distortion amount according to the present invention;

FIG. 4 is a block diagram showing the main configuration example of an image processing device according to the present invention;

FIG. 5 is a block diagram showing the configuration example of an adjacent pixel difference absolute value phase-based total value calculation unit;

FIG. 6 is a diagram illustrating adjacent pixel difference absolute value phase-based total value calculation;

FIG. 7 is a diagram illustrating adjacent pixel difference absolute value phase-based total value calculation;

FIG. 8 is a diagram illustrating adjacent pixel difference absolute value phase-based total value calculation;

FIG. 9 is a diagram illustrating adjacent pixel difference absolute value phase-based total value calculation;

FIG. 10 is a diagram illustrating adjacent pixel difference absolute value phase-based total value calculation;

FIG. 11 is a diagram illustrating adjacent pixel difference absolute value phase-based total value calculation;

FIG. 12 is a diagram illustrating adjacent pixel difference absolute value phase-based total value calculation;

FIG. 13 is a diagram illustrating adjacent pixel difference absolute value phase-based total value calculation;

FIG. 14 is a diagram illustrating adjacent pixel difference absolute value phase-based total value calculation;

FIG. 15 is a block diagram showing the configuration example of an encoding distortion parameter calculation unit;

FIG. 16 is a diagram illustrating an encoding distortion parameter;

FIG. 17 is a block diagram showing the configuration example of a control unit;

FIG. 18 is a diagram illustrating an example of an encoding block boundary;

FIG. 19 is a diagram illustrating an example of distortion amount detection by a combination of distortion amounts;

FIG. 20 is a diagram illustrating an example of distortion amount detection by a combination of distortion amounts;

FIG. 21 is a flowchart illustrating an example of the flow of image processing;

FIG. 22 is a flowchart illustrating an example of the flow of a process of calculating adjacent pixel different absolute phase-based total value;

FIG. 23 is a flowchart illustrating an example of the flow of an encoding distortion parameter calculation process;

FIG. 24 is a flowchart illustrating an example of the flow of an image processing control process;

FIG. 25 is a diagram illustrating change of an image size;

FIG. 26 is a block diagram illustrating another configuration example of an image processing device;

FIG. 27 is a flowchart illustrating another example of the flow of image processing; and

FIG. 28 is a block diagram showing the main configuration example of a personal computer according to the present invention.

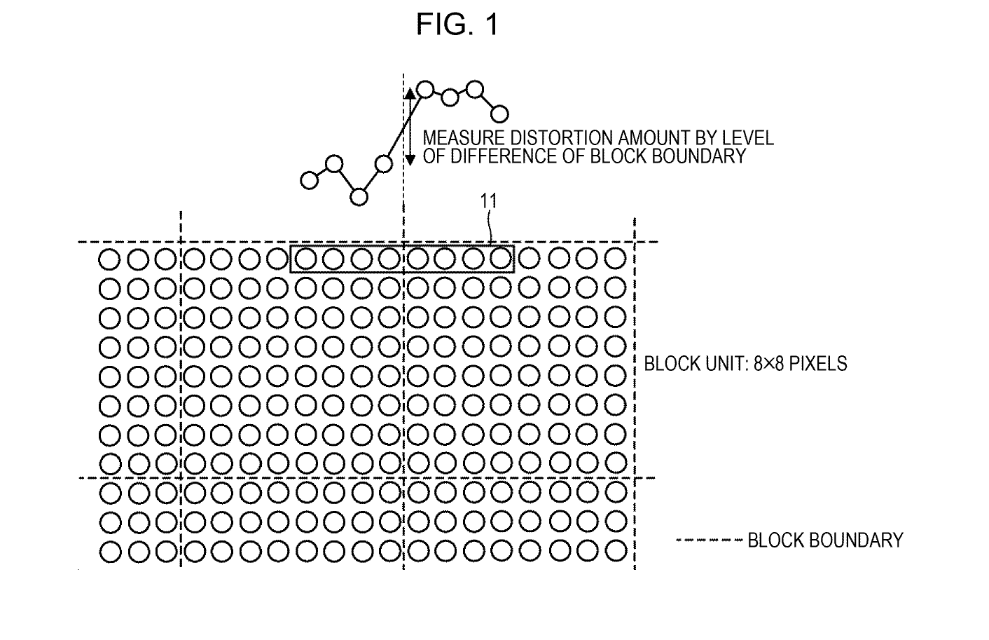

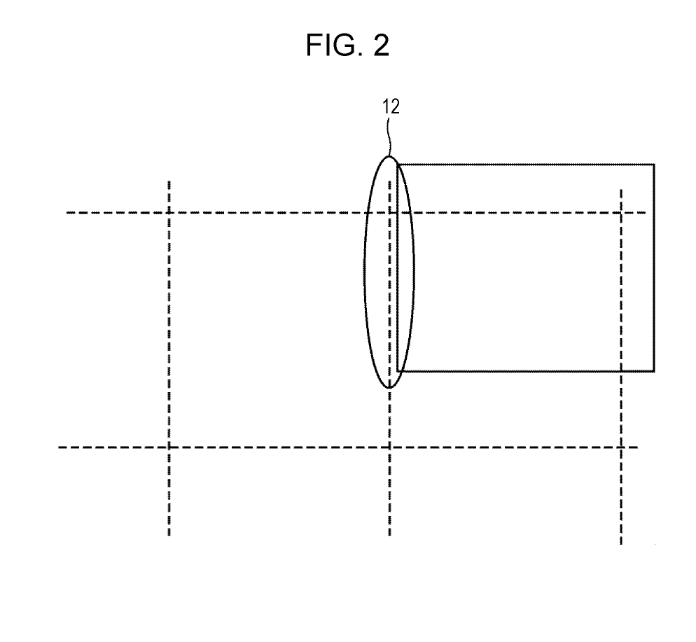

### DESCRIPTION OF THE PREFERRED EMBODIMENTS

Hereinafter, modes (hereinafter, referred to as embodiments) of the invention will be described. The description will be made in the following order.

1. First Embodiment (Image Processing Device)

2. Second Embodiment (Image Processing Device)

3. Third Embodiment (Personal Computer)

### 1. First Embodiment

### [Outline]

If image data is encoded in block units, since each block is independently encoded, direct current is deviated for each block, and a joint of the block is prone to become discontinuous. Such a phenomenon is generally referred to as block distortion.

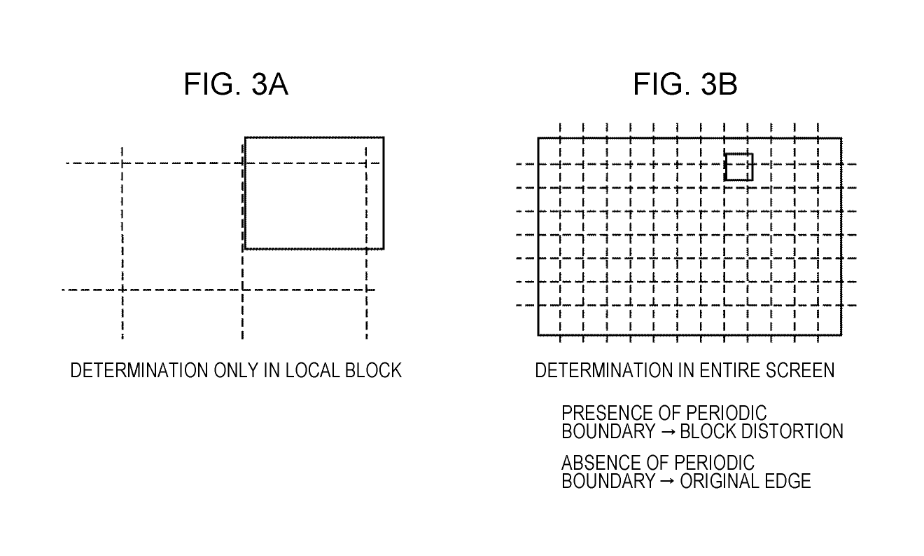

In order to reduce such distortion, block distortion is detected. However, in the related art, as shown in FIG. 3A, a distortion amount is detected in a local area. For example, a place where a difference in pixel value between adjacent pixels is large is detected as a place where block distortion occurs.

However, this difference is increased even in an original edge component of an image. Accordingly, even when a block boundary position is estimated using a setting value or the like of a block size, if a block boundary and an edge component are positioned to be close to each other, it is difficult to accurately distinguish the block boundary and the edge component. By the erroneous detection of the edge component, distortion amount detection becomes inaccurate. Thus, it is difficult to accurately reduce block distortion.

However, in a general image, a block boundary is periodically present over the entire image. That is, block distortion may periodically occur over the entire image. In contrast, the edge component of the image may locally occur.

In the below-described present invention, using such a characteristic difference, as shown in FIG. 3B, block distortion is detected in the entire image. In this way, it is possible to more accurately identify whether a part in which a detected pixel value is large is an edge component or block distortion.

### [Configuration of Image Processing Device]

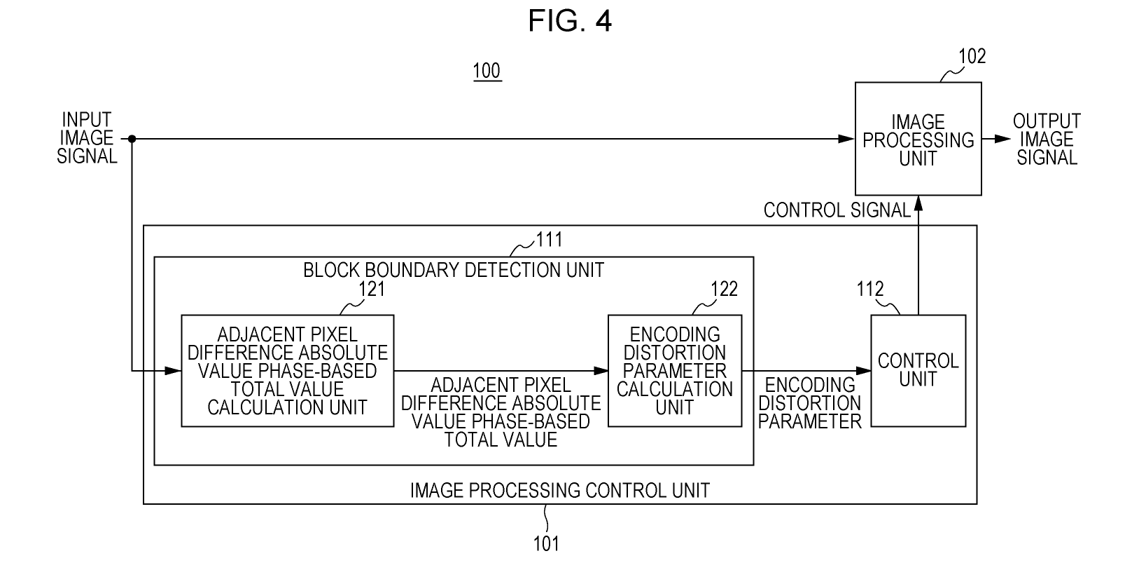

FIG. 4 is a block diagram showing the main configuration example of an image processing device according to the present invention.

The image processing device 100 shown in FIG. 4 is a device for performing image processing with respect to an input image signal and outputting an output image signal. The image processing device 100 includes an image processing control unit 101 and an image processing unit 102.

The image processing unit 102 performs, for example, a filter process of reducing block distortion or an emphasis process (sharpness) for emphasizing an edge component with respect to the input image signal as image processing.

The image processing control unit 101 detects block distortion from the input image signal and control an operation of the image processing unit 102 using the detected result. For example, if the image processing unit 102 performs the filter process of reducing block distortion, the image processing control unit 101 controls a component other than block distortion such as an edge component so as not to be reduced. In addition, for example, if the image processing unit 102 performs the emphasis process of emphasizing the edge component, the image processing control unit 101 controls block distortion so as not to be emphasized.

The image processing control unit 101 includes a block boundary detection unit 111 for detecting a block boundary which is an encoding block boundary from the input image signal and a control unit 112 for controlling the image processing unit 102.

The block boundary detection unit 111 includes an adjacent pixel difference absolute value phase-based total value calculation unit 121 and an encoding distortion parameter calculation unit 122.

The adjacent pixel difference absolute value phase-based total value calculation unit 121 obtains a difference in pixel value between adjacent pixels and calculates a total value every phase. The encoding distortion parameter calculation unit 122 calculates encoding distortion parameters which are various parameters for encoding distortion using the adjacent pixel difference absolute value phase-based total value calculated by the adjacent pixel difference absolute value phase-based total value calculation unit 121.

The control unit 112 generates a control signal for controlling the image processing unit 102 according to the values of the encoding distortion parameters calculated by the encoding distortion parameter calculation unit 122 and supplies the control signal to the image processing unit 102 so as to control an operation of the image processing unit 102.

### [Configuration of Adjacent Pixel Difference Absolute Value Phase-Based Total Value Calculation Unit]

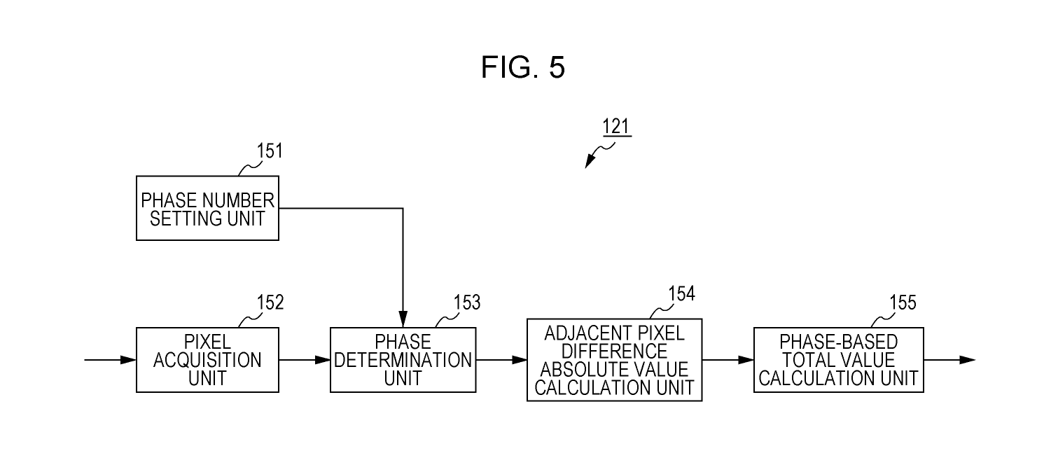

FIG. 5 is a block diagram showing the configuration example of an adjacent pixel difference absolute value phase-based total value calculation unit 121.

As shown in FIG. 5, the adjacent pixel difference absolute value phase-based total value calculation unit 121 includes a phase number setting unit 151, a pixel acquisition unit 152, a phase determination unit 153, an adjacent pixel difference absolute value calculation unit 154 and a phase-based total value calculation unit 155.

The phase number setting unit 151 sets the number of phases. The phase indicates the location of an encoding block of a target pixel and is referred to as a boundary phase. The number of phases is determined by an encoding block size. For example, if the encoding block size of a horizontal direction of an image is 8 pixels, the number of phases is 8.

All pixels of an image belong to several encoding blocks and thus may be classified by a location of an encoding block. For example, if the encoding block size of the horizontal direction of the image is 8 pixels, all the pixels of the image may be classified into 8 types in the horizontal direction on a per phase basis.

The phase number setting unit 151 sets and supplies the number of phases to the phase determination unit 153.

The pixel acquisition unit 152 acquires an input image signal one pixel by one pixel and supplies the input image signal to the phase determination unit 153. The phase determination unit 153 determines to which phase the pixel to which data is supplied from the pixel acquisition unit 152 belongs. The phase determination unit 153 supplies the data of the pixel and the phase determination result to the adjacent pixel difference absolute value calculation unit 154.

The adjacent pixel difference absolute value calculation unit 154 calculates an absolute value (difference absolute value) of a difference in pixel value between neighboring pixels (adjacent pixels). That is, the adjacent difference absolute value calculation unit 154 calculates an absolute value of a difference between a pixel value supplied from the phase determination unit 153 and a pixel value supplied from the phase determination unit 153 just in advance. The adjacent pixel difference absolute value calculation unit 154 supplies the calculation result and the phase determination result to the phase-based total value calculation unit 155.

The phase-based total value calculation unit 155 accumulates the adjacent pixel difference absolute value supplied from the adjacent pixel difference absolute value calculation unit 154 on a per phase basis. That is, the phase-based total value calculation unit 155 calculates a phase-based total value (adjacent pixel difference absolute value phase-based total value) of an adjacent pixel difference absolute value. For example, if the number of phases is 8 in the horizontal direction of the image, the calculated adjacent pixel difference absolute value phase-based total value becomes 8.

The phase-based total value calculation unit 155 obtains the adjacent pixel difference absolute value phase-based total value with respect to pixels of one frame and supplies the adjacent pixel difference absolute value phase-based total value to the encoding distortion parameter calculation unit 122 (FIG. 4).

### [Adjacent Pixel Difference Absolute Phase-Based Total Value]

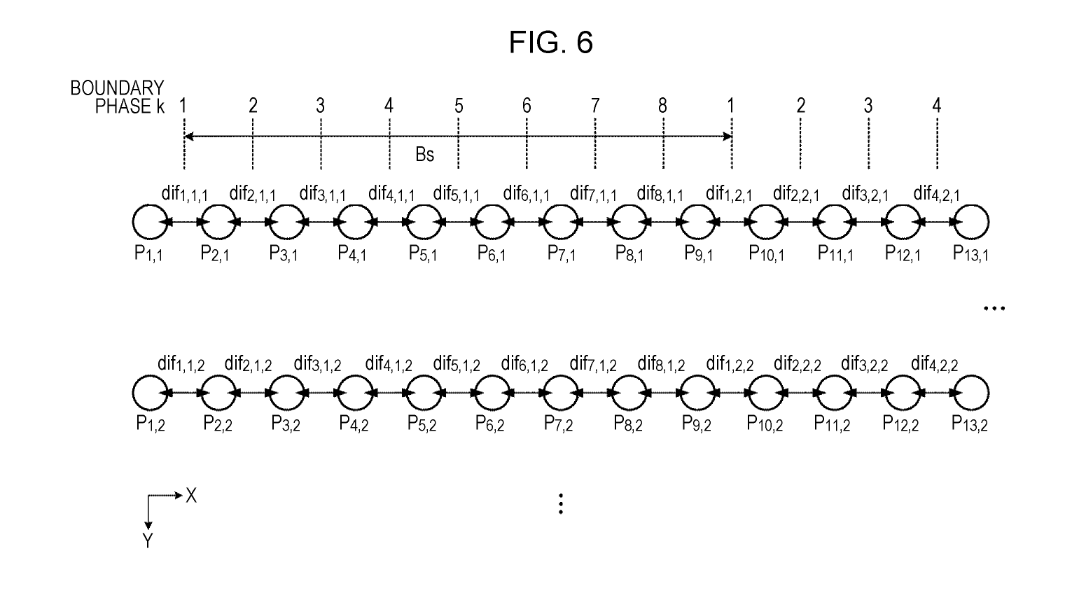

An example of calculating the adjacent pixel difference absolute value phase-based total value in the horizontal direction of the image will be described. FIG. 6 is a diagram illustrating adjacent pixel difference absolute value phase-based total value calculation.

An image value of an input image is Pᵢⱼ (i=1, 2, . . . , N, j=1, 2, . . . , M) (N: the horizontal pixel number of the input image, M: the vertical pixel number of the input image). In addition, the encoding block size of the horizontal direction is Bs. A boundary phase k is expressed by the following Equation (1).

k=(i mod Bs)+1 (1)

That is, a value obtained by adding 1 to a surplus (remainder) of the encoding block size of a location i of the horizontal direction of a pixel becomes a boundary phase k. If Bs=8, the boundary phase becomes 1, 2, 3, . . . , 7, 8, 1, 2, 3, . . . (subsequently repeated) from a left end of the input image as shown in an upper side of FIG. 6.

An adjacent pixel difference absolute value dif_{k, h, j} is calculated by the following Equations (2) and (3) (h is an integer).

dif_{k,h,j}=|P_{i,j}−Pᵢ₊₁| (2)

h=i/Bs (3)

That is, as shown in FIG. 6, the absolute value of the difference in pixel value between neighboring pixels is calculated.

Using the adjacent pixel difference absolute value dif_{k, h, j} calculated as described above, a total value Sumₖ of each boundary phase k is calculated by the following Equation (4).

$${Sum}_{k} = {\sum }_{h = 1}^{N / Bs} {\sum }_{J = 1}^{M} {dif}_{k , h , j} \qquad ( 4 )$$

As shown in FIG. 6, since the boundary phase k of the horizontal direction is changed in the horizontal direction, the pixels arranged in the vertical direction have the same phase. That is, the calculated adjacent pixel difference absolute value dif_{k, h, j} are summed in the vertical direction of the image (for each column).

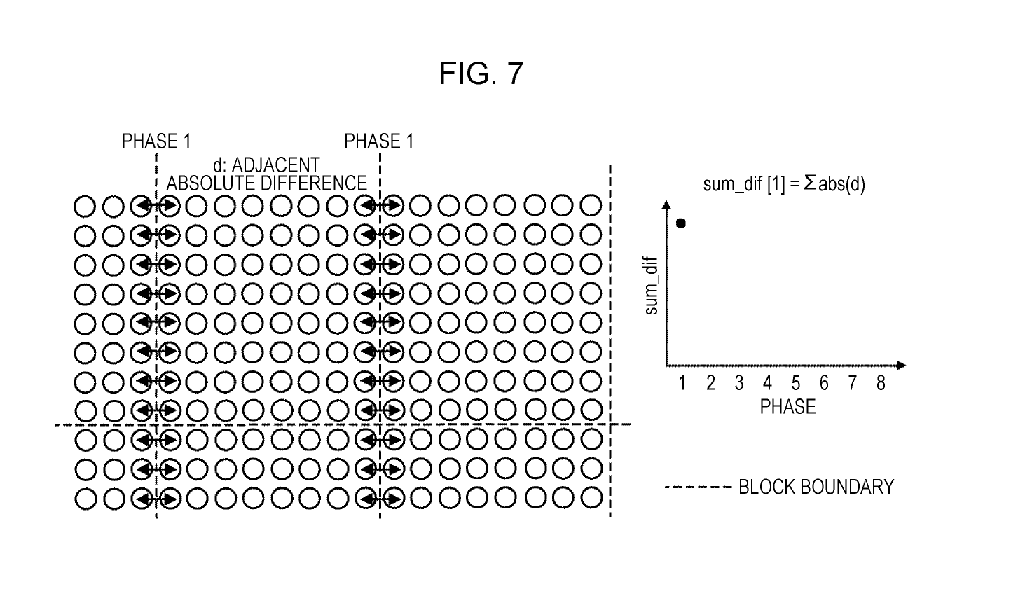

For example, as shown in FIG. 7, the phase-based total value calculation unit 155 sums the adjacent pixel difference absolute value of a column of a phase 1 which is assumed as an encoding block boundary phase and calculates a sum Sum₁ (also referred to as sum_diff[1]).

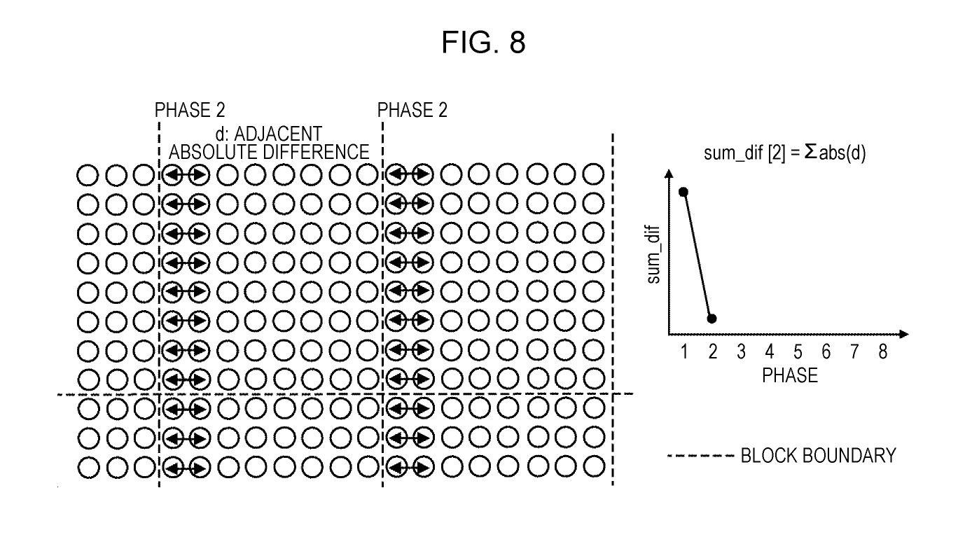

Next, as shown in FIG. 8, the phase-based total value calculation unit 155 sums the adjacent pixel difference absolute value in a column of a phase 2 located on just the right side of the column of the phase 1 in a column direction and calculates a sum Sum₂ (also referred to as sum_diff[2]).

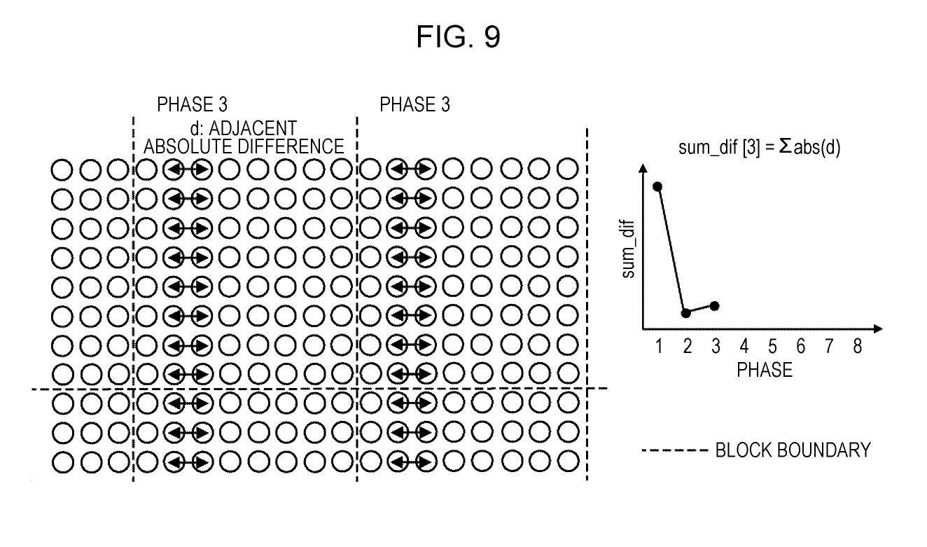

Next, as shown in FIG. 9, the phase-based total value calculation unit 155 sums the adjacent pixel difference absolute value in a column of a phase 3 located on just the right side of the column of the phase 2 in a column direction and calculates a sum Sum₃ (also referred to as sum_diff[3]).

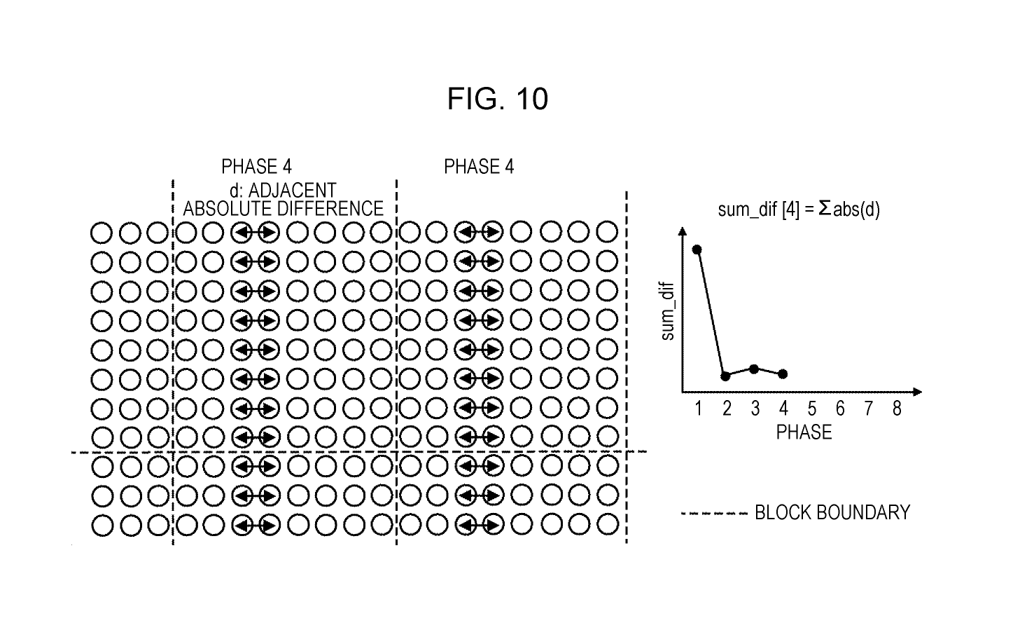

Next, as shown in FIG. 10, the phase-based total value calculation unit 155 sums the adjacent pixel difference absolute value in a column of a phase 4 located on just the right side of the column of the phase 3 in a column direction and calculates a sum Sum₄ (also referred to as sum_diff[4]).

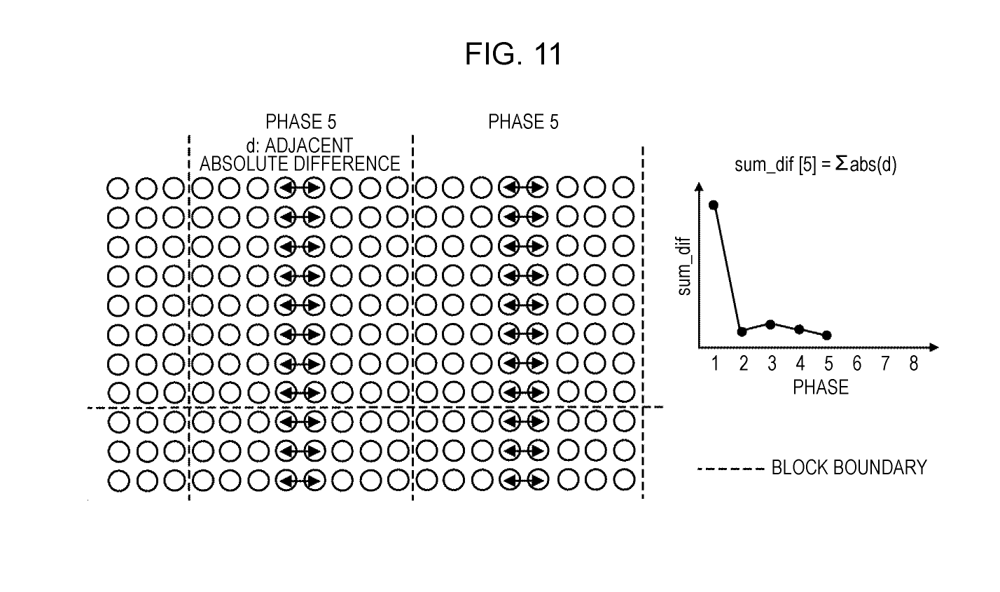

Next, as shown in FIG. 11, the phase-based total value calculation unit 155 sums the adjacent pixel difference absolute value in a column of a phase 5 located on just the right side of the column of the phase 4 in a column direction and calculates a sum Sum₅ (also referred to as sum_diff[5]).

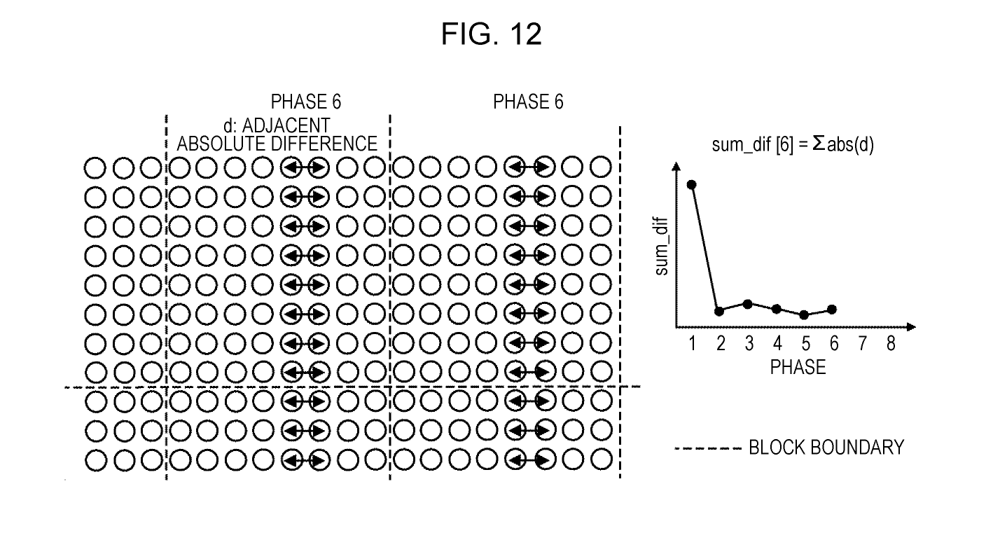

Next, as shown in FIG. 12, the phase-based total value calculation unit 155 sums the adjacent pixel difference absolute value in a column of a phase 6 located on just the right side of the column of the phase 5 in a column direction and calculates a sum Sum₆ (also referred to as sum_diff[6]).

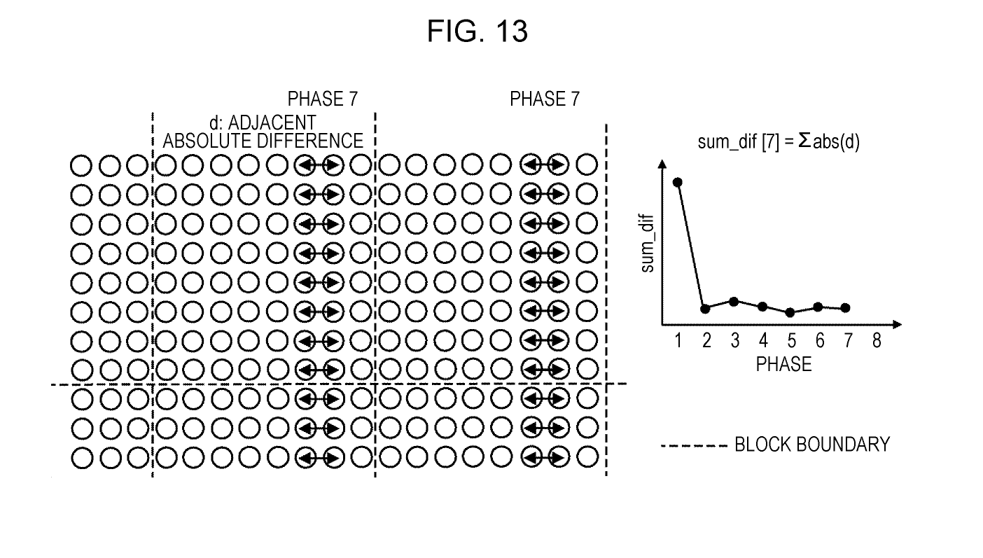

Next, as shown in FIG. 13, the phase-based total value calculation unit 155 sums the adjacent pixel difference absolute value in a column of a phase 7 located on just the right side of the column of the phase 6 in a column direction and calculates a sum Sum₇ (also referred to as sum_diff[7]).

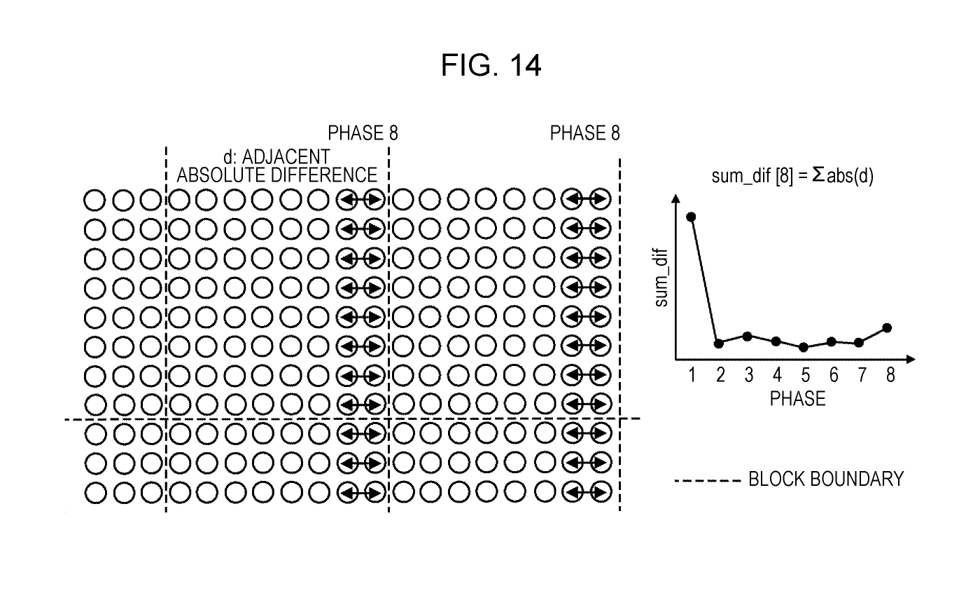

Next, as shown in FIG. 14, the phase-based total value calculation unit 155 sums the adjacent pixel difference absolute value in a column of a phase 8 located on just the right side of the column of the phase 7 in a column direction and calculates a sum Sum₈ (also referred to as sum_diff[8]).

The adjacent pixel difference absolute value is summed on a per phase basis and, as shown in the graphs of FIGS. 7 to 14, the adjacent pixel difference absolute value phase-based total value Sumₖ (also referred to as sum_diff[k]) is obtained.

Although the adjacent pixel difference absolute value is obtained with respect to all the pixels of the image and then the adjacent pixel difference absolute value phase-based total value is obtained in the above description, this order is arbitrary. For example, whenever the image acquisition unit 152 acquires the pixel value of one pixel, the adjacent pixel difference absolute value calculation unit 154 may obtain the adjacent pixel difference absolute value and the phase-based total value calculation unit 155 may add the adjacent pixel difference absolute value to the total value of the corresponding phase (accumulation for each phase). If the total value of each phase is finally calculated, the order may be arbitrary.

### [Configuration of Encoding Distortion Parameter Calculation Unit]

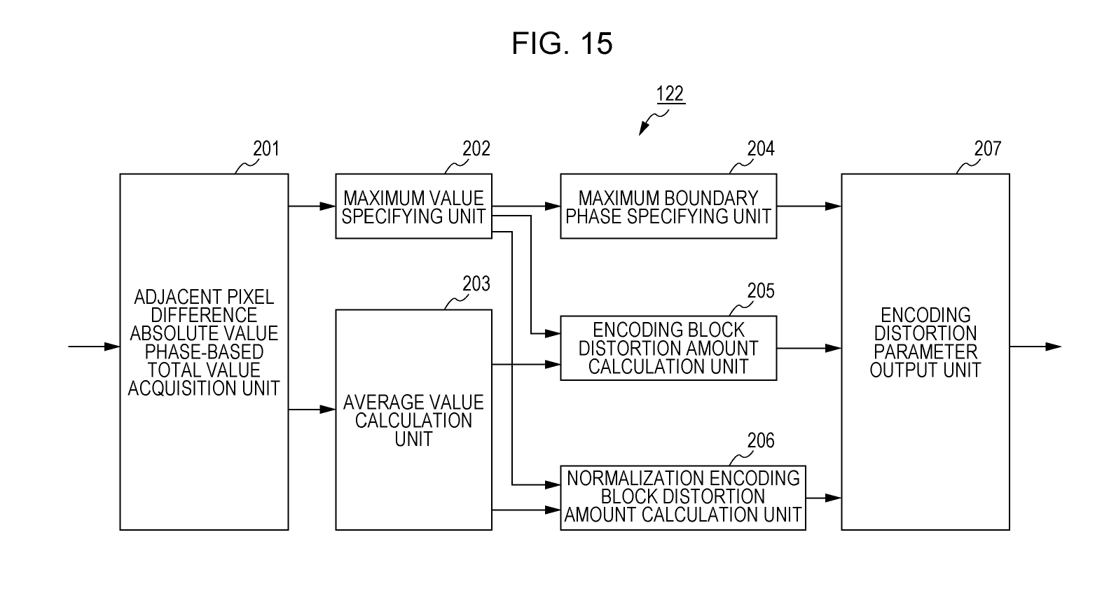

FIG. 15 is a block diagram showing the configuration example of the encoding distortion parameter calculation unit 122.

As shown in FIG. 15, the encoding distortion parameter calculation unit 122 includes an adjacent pixel difference absolute value phase-based total value acquisition unit 201, a maximum value specifying unit 202, and an average value calculation unit 203. The encoding distortion parameter calculation unit 122 includes a maximum boundary phase specifying unit 204, an encoding block distortion amount calculation unit 205, a normalization encoding block distortion amount calculation unit 206, and an encoding distortion parameter output unit 207.

The adjacent pixel difference absolute value phase-based total value acquisition unit 201 acquires the adjacent pixel difference absolute value phase-based total values supplied from the adjacent pixel difference absolute value phase-based total value calculation unit 121. The adjacent pixel difference absolute value phase-based total value acquisition unit 201 supplies the acquired adjacent pixel difference absolute value phase-based total value to the maximum value specifying unit 202 and the average value calculation unit 203.

The maximum value specifying unit 202 specifies a maximum value among the total values of the adjacent pixel difference absolute values of the respective phases acquired by the adjacent pixel difference absolute value phase-based total value acquisition unit 201. For example, if the number of phases is 8, the adjacent pixel difference absolute value phase-based total value acquisition unit 201 acquires 8 adjacent pixel difference absolute value phase-based total values. The maximum value specifying unit 202 specifies a maximum value of the eight values.

The maximum value specifying unit 202 supplies the adjacent pixel difference absolute value phase-based total values and information indicating the maximum value thereof to the maximum boundary phase specifying unit 204, the encoding block distortion amount calculation unit 205 and the normalization encoding block distortion amount calculation unit 206.

The average value calculation unit 203 calculates an average of the adjacent pixel difference absolute values of the respective phases acquired by the adjacent pixel difference absolute value phased-based total value acquisition unit 201. For example, if the number of phases is 8, the adjacent pixel difference absolute value phased-based total value acquisition unit 201 acquires 8 adjacent pixel difference absolute value phase-based total values. The average value calculation unit 203 specifies an average value of the eight values.

The average value calculation unit 203 supplies the adjacent pixel difference absolute value phase-based total values and the calculated average value to the encoding block distortion amount calculation unit 205 and the normalization encoding block distortion amount calculation unit 206.

The maximum boundary phase specifying unit 204 specifies a phase of the maximum value specified by the maximum value specifying unit 202 as a maximum boundary phase kmax. This maximum boundary phase kmax is one of encoding distortion parameters. The maximum boundary phase specifying unit 204 supplies the maximum boundary phase kmax to the encoding distortion parameter output unit 207.

The encoding block distortion amount calculation unit 205 calculates an encoding block distortion amount representing a level of block distortion occurring between encoding blocks using the maximum value specified by the maximum value specifying unit 202 and the average value calculated by the average value calculation unit 203. The encoding block distortion amount is one of encoding distortion parameters. The encoding block distortion amount calculation unit 205 supplies the encoding block distortion amount to the encoding distortion parameter output unit 207.

The normalization encoding block distortion amount calculation unit 206 calculates a normalization encoding block distortion amount obtained by normalizing the encoding block distortion amount using the maximum value specified by the maximum value specifying unit 202 and the average value calculated by the average value calculation unit 203. The normalization encoding block distortion amount is one of encoding distortion parameters. The normalization encoding block distortion amount calculation unit 206 supplies the normalization encoding block distortion amount to the encoding distortion parameter output unit 207.

The encoding distortion parameter output unit 207 supplies the encoding distortion parameters supplied from the respective units to the control unit 112 (FIG. 4).

### [Encoding Distortion Parameter]

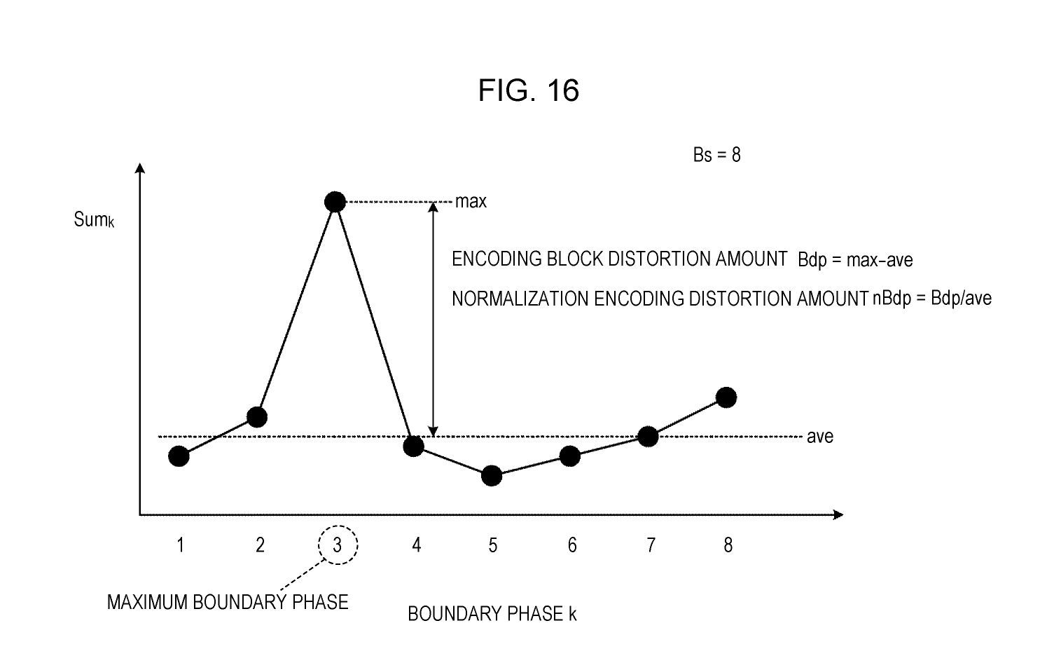

FIG. 16 is a diagram illustrating an encoding distortion parameter.

The maximum value max and the average value ave of adjacent pixel difference absolute value phase-based total value Sumₖ (k=1, 2, . . . , Bs) are calculated by the following equations (5) and (6).

$$\begin{matrix}max = {max}_{h < k < Bs} {Sum}_{k} & ( 5 ) \\ ave = {\sum }_{k = 1}^{Bs} {Sum}_{k} / Bs & ( 6 )\end{matrix}$$

The maximum boundary phase specifying unit 204 specifies the phase of the maximum value max as the maximum boundary phase kmax. In the example of FIG. 16, kmax=3.

The encoding block distortion amount calculation unit 205 calculates the encoding block distortion amount Bdp using the maximum value max and the average value ave as expressed by the following Equation (7). The normalization encoding block distortion amount calculation unit 206 calculates the normalization encoding block distortion amount nBdp using the maximum value max and the average value ave (the calculated encoding block distortion amount Bdp) as expressed by the following Equation (8).

Bdp=max−ave (7)

nBdp=Bdp/ave=(max/ave)−1 (8)

These values are supplied to the control unit 112 as the encoding distortion parameters.

Although the encoding distortion parameters are calculated in the horizontal direction of the image in the above description, such encoding distortion parameters may be calculated in the vertical direction of the image. The phase may be set not only in the horizontal direction but also in the vertical direction. Accordingly, even in the case of the vertical direction, similarly to the above-described case of the horizontal case, the adjacent pixel difference absolute value phase-based total value may be calculated and each encoding distortion parameter may be obtained.

If the encoding distortion parameters are calculated in the horizontal direction, the adjacent pixel difference absolute value is obtained when the pixel acquisition unit 152 acquires the pixel value and the phase-based total value of the corresponding phase may be accumulated. That is, in order to calculate the adjacent pixel difference absolute value of the horizontal direction, the pixel value of the previous pixel is held. In contrast, in order to calculate the adjacent pixel difference absolute value of the vertical direction, pixel values of one or more lines have to be held. Accordingly, if the encoding distortion parameters are calculated in the horizontal direction, it is possible to reduce a necessary memory amount compared with the case of calculating the encoding distortion parameters in the vertical direction.

Alternatively, the encoding distortion parameters may be calculated in both the horizontal direction and the vertical direction.

### [Configuration of Control Unit]

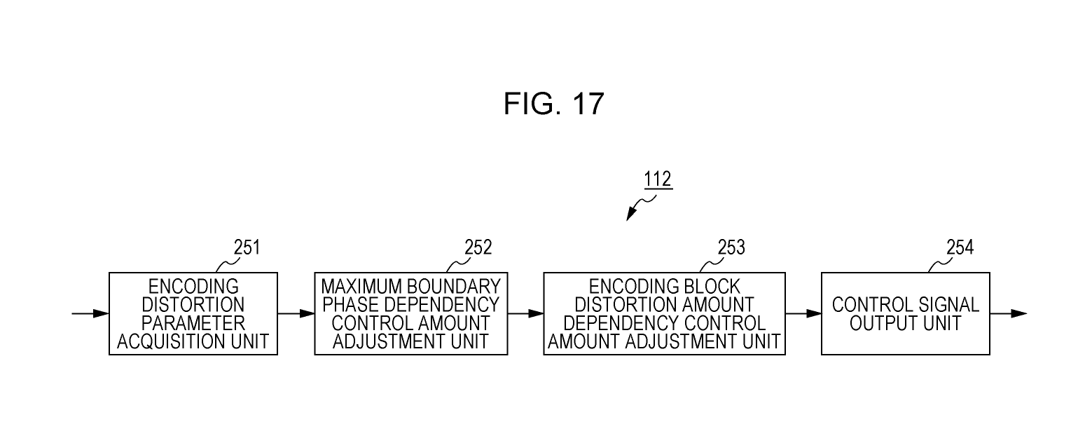

FIG. 17 is a block diagram showing the configuration example of the control unit.

As shown in FIG. 17, the control unit 112 includes an encoding distortion parameter acquisition unit 251, a maximum boundary phase dependency control amount adjustment unit 252, an encoding block distortion amount dependency control amount adjustment unit 253 and a control signal output unit 254.

The encoding distortion parameter acquisition unit 251 acquires the encoding distortion parameters output from the encoding distortion parameter output unit 207 and supplies the encoding distortion parameters to the maximum boundary phase dependency control amount adjustment unit 252.

The maximum boundary phase dependency control amount adjustment unit 252 performs control amount adjustment using the maximum boundary phase kmax among the encoding distortion parameters. The maximum boundary phase dependency control amount adjustment unit 252 regards the maximum boundary phase kmax as an encoding block boundary and performs control amount adjustment of the image processing unit 102 so as to reduce the encoding block distortion amount which appears in this phase.

The encoding block distortion amount dependency control amount adjustment unit 253 performs control amount adjustment using the encoding block distortion amount Bdp or the normalization encoding block distortion amount nBdp among the encoding distortion parameters.

The control signal output unit 254 supplies a control signal adjusted according to the maximum boundary phase dependency control amount adjustment unit 252 or the encoding block distortion amount dependency control amount adjustment unit 253 to the image processing unit 102 and controls image processing of the input image signal by the image processing unit 102.

### [Maximum Boundary Phase]

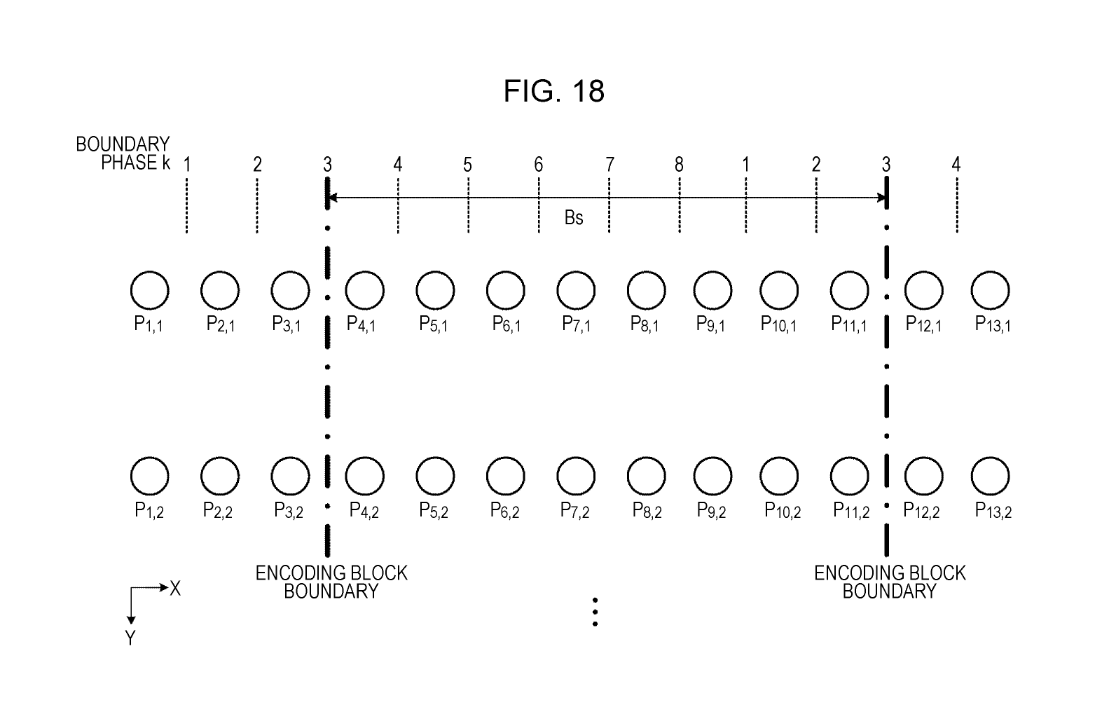

FIG. 18 is a diagram illustrating an example of an encoding block boundary.

The maximum boundary phase kmax is a phase having a largest adjacent pixel difference absolute value over the entire screen. In the case of an edge component which locally appears, an adjacent pixel difference absolute value of that portion is increased, but a significantly large value is not obtained in the phase-based total value over the entire image. In contrast, since the encoding block boundary extends in the entire image, the adjacent pixel difference absolute value phase-based total value of that phase becomes greater than other phase, as shown in FIG. 16.

That is, the maximum boundary phase kmax is a phase having a highest encoding block boundary possibility. The maximum boundary phase dependency control amount adjustment unit 252 regards the maximum boundary phase kmax as an encoding block boundary and estimates the location of the encoding block. That is, the encoding block boundary is set between a p-th pixel and a (p+1)-th pixel from the left end of the image using p calculated as expressed by the following Equation (9).

Encoding block boundary=kmax+Bs(h−1) (9)

where, h=1, 2, . . . , N/Bs (N is a horizontal pixel number of an input image)

For example, similarly to the example of FIG. 16, if the maximum boundary phase kmax=3, as shown in FIG. 18, the boundary phase k=3 is regarded as the encoding block boundary. That is, the encoding block boundary is set at every Bs=8 pixels between a third pixel and a fourth pixel and between an eleventh pixel and a twelfth pixel from the left end in the horizontal direction.

The maximum boundary phase dependency control amount adjustment unit 252 may more accurately specify the encoding block boundary. Accordingly, the maximum boundary phase dependency control amount adjustment unit 252 may control the image processing unit 102 so as to more accurately reduce encoding block distortion.

For example, if the image processing unit 102 performs a filter process of reducing encoding block distortion with respect to the input image signal, the maximum boundary phase dependency control amount adjustment unit 252 more accurately applies the filter process with respect to only the encoding block boundary and does not apply the filter process to a portion other than the encoding block boundary.

For example, if the image processing unit 102 performs an emphasis process (sharpness) of emphasizing an edge component, the maximum boundary phase dependency control amount adjustment unit 252 more accurately applies the emphasis process to a portion other than the encoding block boundary and does not apply the emphasis process to the encoding block boundary.

In the embedded edited image or the like, the encoding block boundary may be deviated from the end of the image. However, since the maximum boundary phase dependency control amount adjustment unit 252 detects the encoding block boundary using the maximum boundary phase kmax as described above, it is possible to more accurately detect the encoding block boundary between any pixels. That is, it is possible to cope with the deviation from the end of the image of the encoding block.

### [Encoding Block Distortion Amount]

As described above, since the precision of the specifying of the encoding block boundary is improved, the encoding block distortion amount dependency control amount adjustment unit 253 may obtain a more accurate encoding block distortion amount Bdp and normalization encoding block distortion amount nBdp. Thus, the encoding block distortion amount dependency control amount adjustment unit 253 may control the image processing unit 102 to more appropriately reduce the encoding block distortion.

For example, if the image processing unit 102 performs the filter process of reducing the encoding block distortion with respect to the input image signal, the encoding block distortion amount dependency control amount adjustment unit 253 may more appropriately control the intensity (reduction degree) of the filter process.

In addition, for example, if the image processing unit 102 performs the emphasis process (sharpness) of emphasizing the edge component, the encoding block distortion amount dependency control amount adjustment unit 253 may more appropriately control the intensity such that the emphasis process is performed so as not to emphasize the encoding block distortion.

The encoding block distortion amount dependency control amount adjustment unit 253 more accurately performs control using both the encoding block distortion amount Bdp and the normalization encoding block distortion amount nBdp among the encoding distortion parameters.

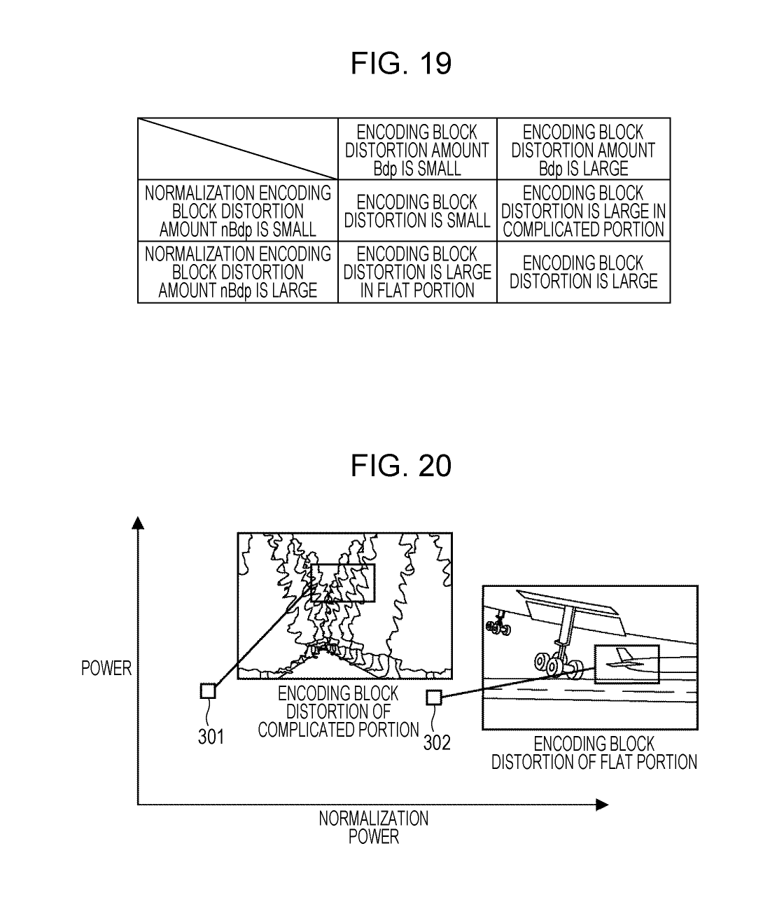

For example, the encoding block distortion amount dependency control amount adjustment unit 253 determines the level of the encoding block distortion by the value of the encoding block distortion amount Bdp or the normalization encoding block distortion amount nBdp among the encoding distortion parameters, as in a table shown in FIG. 19.

In the table shown in FIG. 19, if the encoding block distortion amount Bdp is small and the normalization encoding block distortion amount nBdp is small, the encoding block distortion amount dependency control amount adjustment unit 253 determines that the encoding block distortion of the image is small. If the encoding block distortion amount Bdp is small and the normalization encoding block distortion amount nBdp is large, it is determined that the encoding block distortion of the image is large in a flat image with a small edge component.

If the encoding block distortion amount Bdp is large and the normalization encoding block distortion amount nBdp is small, it is determined that the encoding block distortion of the image is large in a complicated image with many edge components or the like. If the encoding block distortion amount Bdp is large and the normalization encoding block distortion amount nBdp is large, it is determined that the encoding block distortion of the image is large.

For example, if the image processing unit 102 performs the filter process so as to reduce the encoding block distortion generated in the input image, the encoding block distortion amount dependency control amount adjustment unit 253 controls the level of the noise reduction effect of the filter process according to the encoding block distortion amount Bdp (or the normalization encoding block distortion amount nBdp).

In general, in such a filter process, it is difficult to reduce only the encoding block distortion. That is, a high frequency component may be reduced in addition to the encoding block distortion.

The encoding block distortion amount dependency control amount adjustment unit 253 may more precisely detect the characteristics of the encoding distortion in the input image as described above, by using two parameters of the encoding block distortion amount Bdp and the normalization encoding block distortion amount nBdp.

FIG. 20 is a diagram illustrating an example of distortion amount detection by a combination of distortion amounts.

As shown in FIG. 20, in the case of a complicated image 301 having many high frequency components, block distortion may not be visually conspicuous. If the block distortion is reduced by the filter process, a possibility that the high frequency components are reduced is high. That is, image quality deterioration by the filter process may be comparatively increased.

In contrast, in the case of a flat image 302 having many low frequency components, block distortion may be visually conspicuous. Even when the block distortion is reduced by the filter process, since the number of high frequency components prone to be influenced by the filter process is small, image quality deterioration by the filter process is relatively low.

Based on the characteristic difference, for example, the encoding block distortion amount dependency control amount adjustment unit 253 may adjust the control amount such that the noise reduction effect becomes weak in the complicated image 301 and adjust the control amount such that the noise reduction effect becomes strong in the flat image 302.

### [Flow of Image Processing]

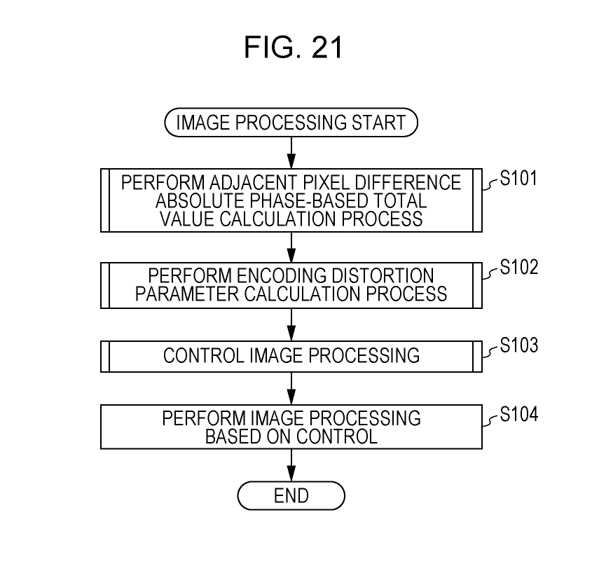

Next, the flow of a process executed by the above-described units will be described. First, the example of the flow of the image processing executed by the image processing device 100 will be described with reference to the flowchart of FIG. 21.

When an image signal is input, the image processing device 100 executes image processing. If the image processing begins, the adjacent pixel difference absolute value phase-based total value calculation unit 121 of the block boundary detection unit 111 of the image processing control unit 101 performs an adjacent pixel difference absolute value phase-based total value calculation process in step S101.

In step S102, the encoding distortion parameter calculation unit 122 of the block boundary detection unit 111 of the image processing control unit 101 performs an encoding distortion parameter calculation process.

In step S103, the control unit 112 of the image processing control unit 101 controls the image processing.

In step S104, the image processing unit 102 performs image processing under the control of the image processing control unit 101. For example, the image processing unit 102 may perform image processing such as a filter process of suppressing block distortion or an emphasis process (sharpness) of emphasizing an edge component with respect to the input image signal, according to a control signal supplied from the image processing control unit 101. The suppression amount, and the emphasis amount or the like may be designated by the control signal supplied from the image processing control unit 101.

If the image processing of the input image signal is completed, the image processing device 100 completes the image processing.

### [Flow of Adjacent Pixel Difference Absolute Value Phase-Based Total Value Calculation Process]

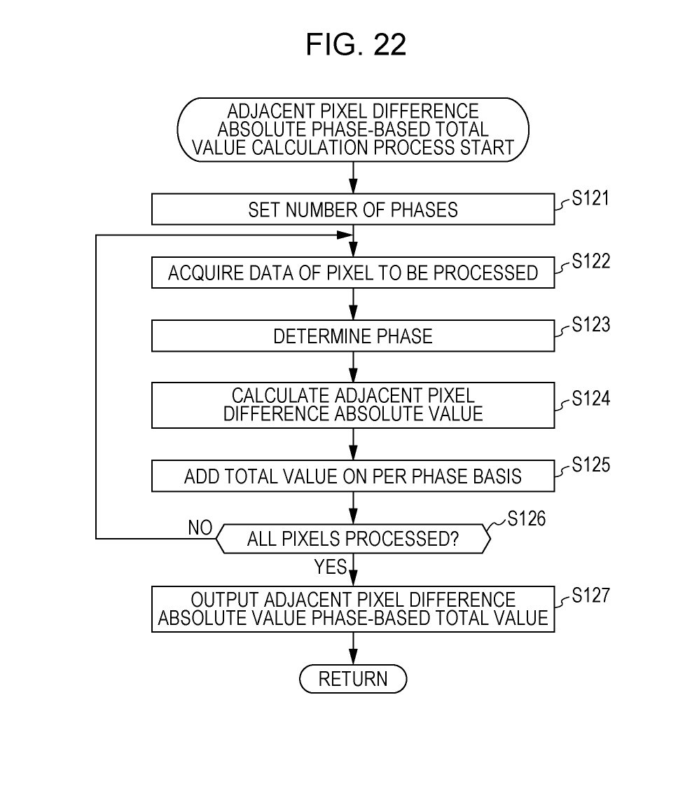

Next, the example of the flow of the adjacent pixel difference absolute value phase-based total value calculation process executed in step S101 of FIG. 21 will be described with reference to the flowchart of FIG. 22.

If the adjacent pixel difference absolute value phase-based total value calculation process begins, the phase number setting unit 151 of the adjacent pixel difference absolute value phase-based total value calculation unit 121 sets an encoding block size of the input image as the number of phases in step S121.

In step S122, the pixel acquisition unit 152 acquires data of a pixel to be processed. In step S123, the phase determination unit 153 determines the phase of the pixel to be processed. In step S124, the adjacent pixel difference absolute value calculation unit 154 calculates an adjacent pixel difference absolute value. For example, if the adjacent pixel difference absolute value of the horizontal direction is calculated, the adjacent pixel difference absolute value calculation unit 154 calculates the absolute value of the difference between a previously acquired pixel value and a currently acquired pixel value.

If the pixel to be processed is a pixel of a right end of an image, a pixel adjacent to the right is not present. In this case, the adjacent pixel difference absolute value calculation unit 154 may omit the calculation of the adjacent pixel difference absolute value and return the process to the step S122 so as to perform the process of a next pixel. For example, the adjacent pixel difference absolute value calculation unit 154 may prepare predetermined dummy data and calculate the adjacent pixel difference absolute value between the dummy data and the pixel to be processed.

In step S125, the phase-based total value calculation unit 155 adds the adjacent pixel difference absolute value calculated in step S124 to the phase-based total value of the phase determined in step S123.

In step S126, the adjacent pixel difference absolute value phase-based total value calculation unit 121 determines whether or not the process is performed with respect to all pixels. If it is determined that unprocessed pixels are present in the image, the process returns to step S122 and the subsequent process is repeated with respect to the unprocessed pixels.

That is, the process of step S122 to step S126 is repeated until all the pixels of the image are processed.

In step S126, if it is determined that all the pixels are processed, the adjacent pixel difference absolute value phase-based total value calculation unit 121 progresses the process to step S127. In step S127, the phase-based total value calculation unit 155 outputs and supplies the accumulated adjacent pixel difference absolute value phase-based total value to the encoding distortion parameter calculation unit 122.

If the process of step S127 is completed, the adjacent pixel difference absolute value phase-based total value calculation unit 121 completes the adjacent pixel difference absolute value phase-based total value calculation process, returns the process to step S101 of FIG. 21, and progresses the process to step S102.

### [Flow of Encoding Distortion Parameter Calculation Process]

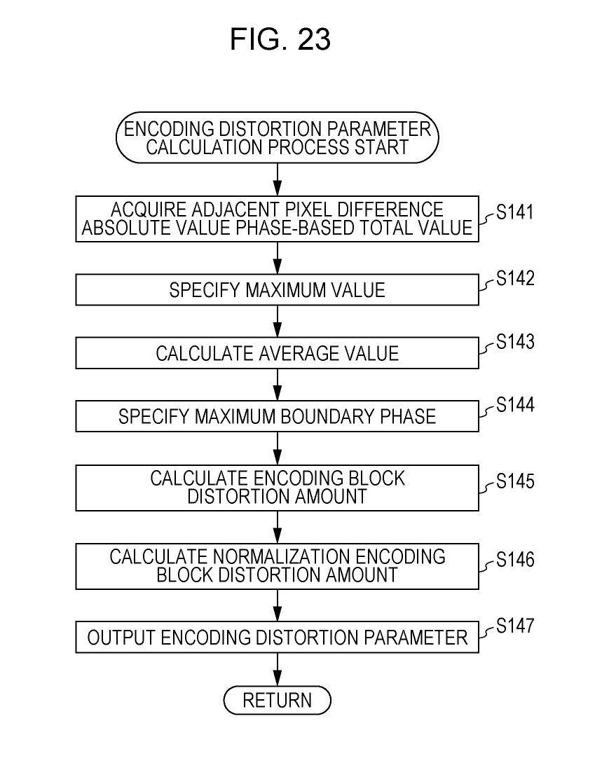

Next, the example of the flow of the encoding distortion parameter calculation process executed in step S102 of FIG. 21 will be described with reference to the flowchart of FIG. 23.

If the encoding distortion parameter calculation process begins, the adjacent pixel difference absolute value phase-based total value acquisition unit 201 of the encoding distortion parameter calculation unit 122 acquires adjacent pixel difference absolute value phase-based total values in step S141.

In step S142, the maximum value specifying unit 202 specifies a maximum value among the adjacent pixel difference absolute value phase-based total values acquired in step S141.

In step S143, the average value calculation unit 203 calculates an average value of the adjacent pixel difference absolute value phase-based total values acquired in step S141.

In step S144, the maximum boundary phase specifying unit 204 specifies the phase of the maximum value specified in step S142 as a maximum boundary phase.

In step S145, the encoding block distortion amount calculation unit 205 calculates an encoding block distortion amount using the maximum value specified in step S142 and the average value calculated in step S143.

In step S146, the normalization encoding block distortion amount calculation unit 206 calculates a normalization encoding block distortion amount using the maximum value specified in step S142 and the average value calculated in step S143.

In step S147, the encoding distortion parameter output unit 207 outputs the maximum boundary phase specified in step S144, the encoding block distortion amount calculated in step S145 and the normalized encoding block distortion amount calculated in step S146 to the control unit 112 as encoding distortion parameters.

If the process of step S147 is completed, the encoding distortion parameter calculation unit 122 completes the encoding distortion parameter calculation process, returns the process to step S102 of FIG. 21, and progresses the process of step S103.

### [Flow of Image Processing Control Process]

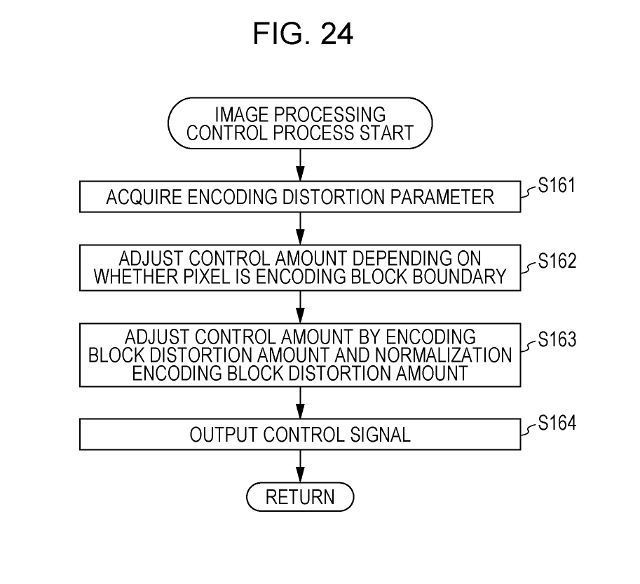

Next, the example of the flow of the image processing control process executed in step S103 of FIG. 21 will be described with reference to the flowchart of FIG. 24.

If the image processing control process begins, the encoding distortion parameter acquisition unit 251 of the control unit 112 acquires the encoding distortion parameters in step S161.

In step S162, the maximum boundary phase dependency control amount adjustment unit 252 adjusts the control amount of the image processing performed by the image processing unit 102, depending on whether the pixel subjected to image processing by the image processing unit 102 is located on the left or right side of the encoding block boundary.

In step S163, the encoding block distortion amount dependency control amount adjustment unit 253 adjusts the control amount of the image processing performed by the image processing unit 102 by the encoding block distortion amount and the normalization encoding block distortion amount.

In step S164, the control signal output unit 254 outputs the control signal of which the control amount is adjusted in step S162 and step S163 to the image processing unit 102.

If the process of step S164 is completed, the control unit 112 completes the image processing control process, returns the process to step S103 of FIG. 21, and progresses the process to step S104.

By performing the processes as described above, specifying the encoding block boundary from the entire image, calculating the distortion amount and controlling the image processing based on these values, the image processing device 100 may improve precision of encoding block distortion reduction.

That is, by calculating the encoding distortion amount using all samples of the input image, the influence of the original edge of the image located at the block boundary location in the input image is reduced and the result of detecting the encoding block distortion amount with high precision is obtained. Thus, the precision of the encoding block distortion reduction by the image processing device 100 is improved.

In addition, the image processing device 100 may calculate the encoding distortion parameters without increasing a computation amount or a necessary memory amount.

Since the location of the encoding block boundary may be estimated, it is possible to perform encoding distortion detection even with respect to the embedded edited image.

The encoding distortion parameters may include parameters other than the above-described parameters. Only some of the above-described encoding distortion parameters may be calculated.

For example, the encoding distortion parameter calculation unit 122 may specify only the maximum boundary phase. In this case, the control unit 112 may estimate at least the maximum boundary phase as the encoding block boundary. Accordingly, the control unit 112 may, for example, control whether or not the image processing unit 102 performs the filter process so as to perform the filter process of reducing the distortion amount only with respect to the pixels located on the left and right sides of the encoding block boundary.

For example, the encoding distortion parameter calculation unit 122 may specify the maximum boundary phase or calculate any one of the encoding block distortion amount or the normalization encoding block distortion amount. If any one of the encoding block distortion amount or the normalization encoding block distortion amount is present, the control unit 112 may adjust the reduction degree of the distortion amount of the pixels on the left and right sides of the encoding block boundary by the image processing unit 102.

For example, the encoding distortion parameter calculation unit 122 may calculate any one of the encoding block distortion amount or the normalization encoding block distortion amount. If any one of the encoding block distortion amount or the normalization encoding block distortion amount is present, the control unit 112 may adjust the reduction degree of the distortion amount of the entire image by the image processing unit 102.

For example, the encoding distortion parameter calculation unit 122 may calculate only the encoding block distortion amount and the normalization encoding block distortion amount. If both the encoding block distortion amount and the normalization encoding block distortion amount are present, the control unit 112 may identify whether the image is complicated or flat as described above and more appropriately adjust the reduction degree of the distortion amount of the entire image.

### 2. Second Embodiment

### [Outline]

The input image may be an image enlarged or reduced from an image size upon encoding. For example, even with respect to a squeeze-format image as an image broadcasted by a terrestrial digital broadcast, the image processing device 100 may improve the precision of the encoding block distortion reduction.

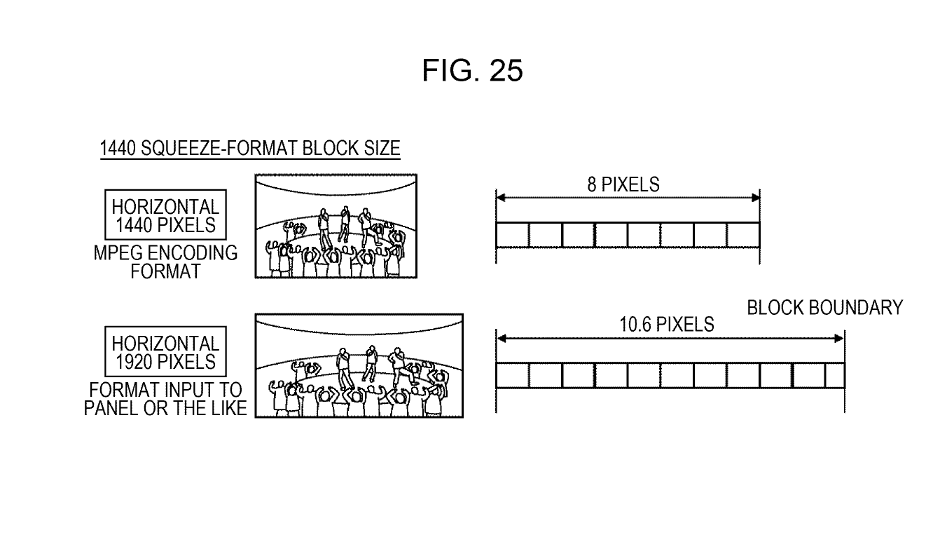

FIG. 25 is a diagram illustrating change of an image size.

As shown in FIG. 25, in the case of the image broadcasted in the terrestrial digital broadcast, an image having 1920 pixels in a horizontal size is reduced to 1440 pixels and then encoded. Upon decoding and display, the horizontal size of the image is returned to 1920 pixels (enlarged in the horizontal direction).

Accordingly, an encoding block size of the horizontal direction which is 8 pixels upon encoding becomes about 10.6 pixels upon display.

Even in this image, in the image processing device, since the number of phases may be arbitrarily set, it is possible to easily improve the precision of the encoding block distortion reduction. Since the number of phases has to be an integer, an image size may be appropriately changed and then a block boundary may be detected.

### [Configuration of Image Processing Device]

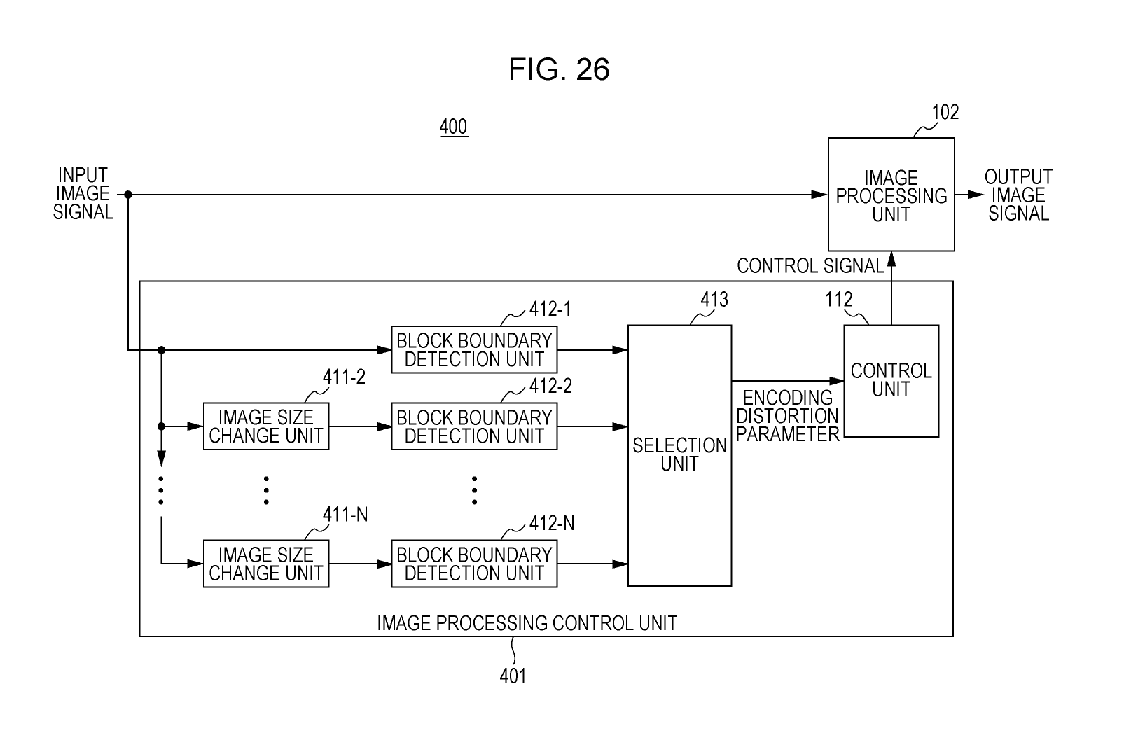

FIG. 26 is a block diagram illustrating another configuration example of an image processing device.

In this case, the image processing device 400 includes an image processing control unit 401 instead of the image processing control unit 101, as shown in FIG. 26. The image processing control unit 401 includes an image size change unit 411-2 to an image size change unit 411-N, a block boundary detection unit 412-1 to a block boundary detection unit 412-N, and a selection unit 413, instead of the block boundary detection unit 111.

The image size change unit 411-2 to the image size change unit 411-N change the input images to different image sizes. If the image size change unit 411-2 to the image size change unit 411-N do not have to be distinguishably described, these units are referred to as the image size change unit 411.

The block boundary detection unit 412-1 to the block boundary detection unit 412-N are equal to the block boundary detection unit 111 as a processing unit. That is, the block boundary detection unit 421-1 to the block boundary detection unit 412-N detect the block boundary from the input image with the image size of the input size or the image size changed by the image size change unit 411-2 to the image size change unit 411-N.

At this time, the number of phases is appropriately adjusted according to the image size. If the block boundary detection unit 412-1 to the block boundary detection unit 412-N do not have to be distinguishably described, these units are referred to as the block boundary detection unit 412.

The selection unit 413 selects and outputs an optimal encoding distortion parameter from the plurality of calculated encoding distortion parameters. For example, the terrestrial digital broadcast signal is encoded to an image size of 1440×1080 pixels and is enlarged to 1920×1080 pixels upon decoding. If the enlarged image becomes an input image, the encoding distortion parameter is calculated in a state of 1920×1080 pixels and the encoding distortion parameter is calculated after being reduced to 1440×1080 pixels.

The selection unit 413 selects and outputs, for example, the larger parameter of both parameters. At this time, since the image size upon encoding may be estimated, it is possible to estimate a block boundary width of the input image by multiplying the maximum boundary phase kmax by the estimated enlargement/reduction ratio.

### [Flow of Image Process]

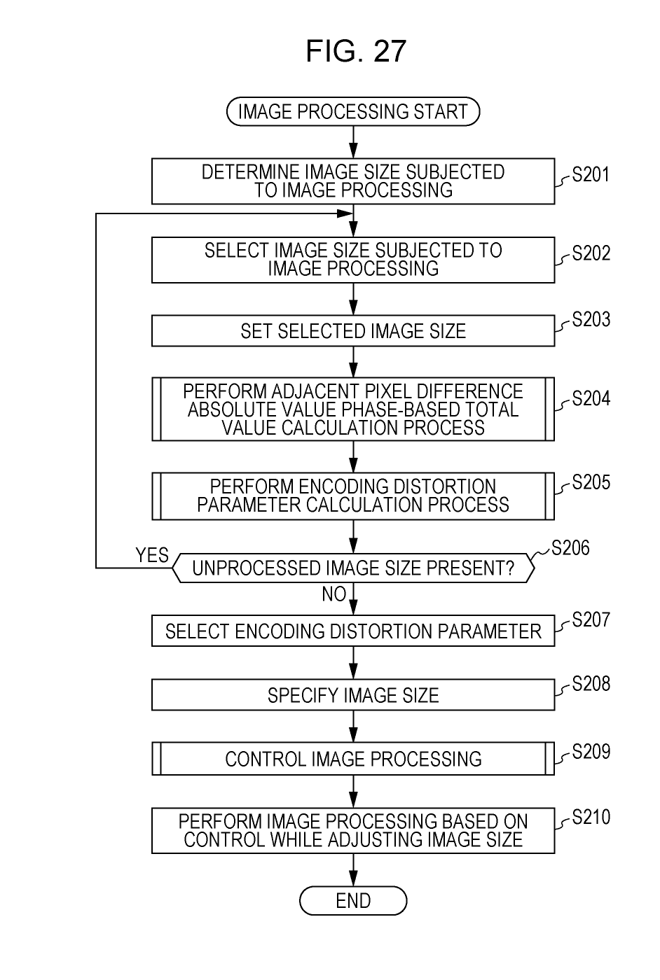

The example of the image processing in this case will be described with reference to the flowchart of FIG. 27.

In step S201, the image processing control unit 401 of the image processing device 400 determines image sizes subjected to image processing. In step S202, the image processing control unit 401 selects one from image sizes subjected to the image processing determined in step S201. In step S203, the image size change unit 411 sets the input image to the selected image size.

The block boundary detection unit 412 performs the adjacent pixel difference absolute value phase-based total value calculation process in step S204 and performs the encoding distortion parameter calculation process in step S205. Such processes are equal to the description of the flowchart of FIG. 22 or 23.

In step S206, the image processing control unit 401 determines whether or not an unprocessed image size is present, returns the process to step S202 if it is determined that the unprocessed image size is present, and repeats the subsequent process with respect to the new unprocessed image size.

In step S206, it is determined that the process is performed with respect to all the image sizes determined in step S201, the image processing control unit 401 progresses to the process to step S207.

In step S207, the selection unit 413 selects an optimal parameter from the encoding distortion parameters calculated for each image size. The selection unit 413 may arbitrarily determine the optimal parameter.

The control unit 112 specifies an image size in step S208, and performs the image processing control process and the image process in step S209. The image processing control process is equal to the description of the flowchart of FIG. 24.

In step S210, the image processing unit 102 performs the image processing under the control of the control unit 112.

If the process of step S210 is completed, the image processing device 400 completes the image processing.

As described above, it is possible to more accurately calculate the encoding distortion parameters even with respect to the input image enlarged or reduced from the image size upon encoding and to more accurately estimate the image size upon encoding simultaneously.

Although the input image is a progressive type image in the above description, the input image may be, for example, an interlace type image. Even in this case, the image processing device may perform the process similarly to the above-described frame image, for each field image.

### 3. Third Embodiment

### [Personal Computer]

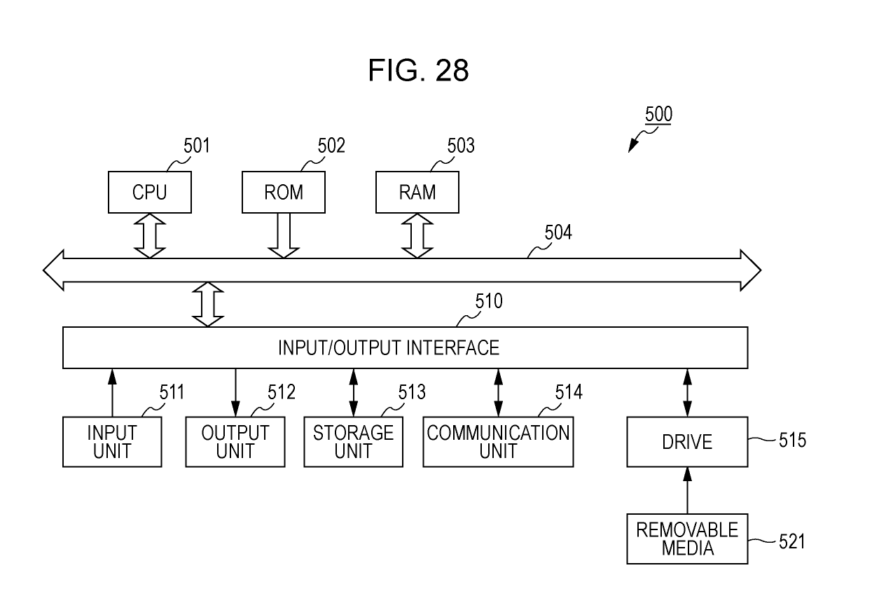

The above-described series of processes may be executed by hardware or software. In this case, for example, a personal computer shown in FIG. 28 may be configured.

In FIG. 28, a CPU 501 of the personal computer 500 executes various types of processes according to a program stored in a Read Only Memory (ROM) 502 or a program loaded from a storage unit 513 to a Random Access Memory (RAM) 503. Data or the like necessary for executing various types of processes by the CPU 501 is appropriately stored in the RAM 503.

The CPU 501, the ROM 502 and the RAM 503 are connected to each other via a bus 504. This bus 504 is also connected to an input/output interface 510.

An input unit 511 including a keyboard, a mouse or the like, a display including a Cathode Ray Tube (CRT), a Liquid Crystal Display (LCD) or the like, an output unit 512 including a speaker or the like, a storage unit 513 including a hard disk or the like, and a communication unit 514 including a modem or the like are connected to the input/output interface 510. The communication unit 514 performs a communication process through a network including the Internet.

If necessary, a drive 515 is connected to the input/output interface 510, a removable media 521 such as a magnetic disk, an optical disc, a magnetooptical disc or a semiconductor memory is appropriately mounted, and a computer program read therefrom is installed in the storage unit 513, if necessary.

If the above-described series of processes is executed by software, a program configuring the software is installed from a network or a recording medium.

This recording medium includes, for example, as shown in FIG. 28, the removable media 521 including a magnetic disk (including a flexible disk), an optical disc (including a Compact Disc-Read Only Memory (CD-ROM) or a Digital Versatile Disc (DVD)), a magnetooptical disc (Mini disc (MD)), a semiconductor memory or the like, in which a program is recorded and which is distributed in order to deliver a program to a user, separately from a device body, the ROM 502 in which a program is recorded and which is delivered to a user in a state of being assembled in the device body in advance, or the hard disk included in the storage unit 513.

The program executed by the computer may be a program for sequentially performing processes in the order described in the present specification or a program for performing processes in parallel or at necessary timings upon calling.

In the present specification, the steps describing the program recorded on the recording medium include processes which are sequentially performed in the described order or processes which are not sequentially executed but are executed in parallel or individually.

In the present specification, the system refers to the whole device including a plurality of devices (apparatuses).

A configuration described as one device (or processing unit) in the above description may include a plurality of devices (or processing units). A configuration described as a plurality of devices (or processing units) in the above description may include one device (or processing unit). The configuration other than the above-described configuration may be added to the configuration of each device (or processing unit). In addition, if the configuration or operation of the whole system is substantially identical, a part of the configuration of a certain device (or processing unit) may be included in the configuration of another device (or another processing unit). That is, the embodiments of the present invention are not limited to the above-described embodiments and various modifications may be made without departing from the scope of the present invention.

The present application contains subject matter related to that disclosed in Japanese Priority Patent Application JP 2010-080523 filed in the Japan Patent Office on Mar. 31, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing control device comprising:
an adjacent pixel difference absolute value phase-based total value calculation unit configured to calculate adjacent pixel difference absolute value phase-based total values obtained by summing adjacent pixel difference absolute values, which are absolute values of differences in pixel value between adjacent pixels of an image subjected to predetermined image processing, with respect to between all the pixels of the image, every phase representing a location between the pixels of an encoding block when the image is encoded;
a maximum boundary phase specifying unit configured to specify a maximum boundary phase which is a phase of a maximum value among the adjacent pixel difference absolute value phase-based total values calculated every phase by the adjacent pixel difference absolute value phase-based total value calculation unit; and
a control unit configured to control the image processing so as to reduce encoding block distortion generated between pixels of the maximum boundary phase specified by the maximum boundary phase specifying unit.

2. The image processing control device according to claim 1, further comprising:
a maximum value specifying unit configured to specify a maximum value among the adjacent pixel difference absolute value phase-based total values calculated every phase by the adjacent pixel difference absolute value phase-based total value calculation unit;
an average value calculation unit configured to calculate an average value of the adjacent pixel difference absolute value phase-based total values calculated every phase by the adjacent pixel difference absolute value phase-based total value calculation unit; and
an encoding block distortion amount calculation unit configured to calculate an encoding block distortion amount of the phase by subtracting the average value calculated by the average value calculation unit from the maximum value specified by the maximum value specifying unit,
wherein the control unit controls the image processing so as to reduce the encoding block distortion generated between the pixels of the maximum boundary phase specified by the maximum boundary phase specifying unit to a degree according to the encoding block distortion amount calculated by the encoding block distortion amount calculation unit.

3. The image processing control device according to claim 2, further comprising a normalization encoding block distortion amount calculation unit configured to normalize the encoding block distortion amount calculated by the encoding block distortion amount calculation unit with the average value calculated by the average value calculation unit and to calculate a normalization encoding block distortion amount of the phase,
wherein the control unit controls the image processing so as to reduce the encoding block distortion generated between the pixels of the maximum boundary phase specified by the maximum boundary phase specifying unit to a degree according to the normalization encoding block distortion amount calculated by the normalization encoding block distortion amount calculation unit and the encoding block distortion amount calculated by the encoding block distortion amount calculation unit.

4. The image processing control device according to claim 3, wherein the control unit decreases a degree of reducing the encoding block distortion generated between the pixels of the maximum boundary phase specified by the maximum boundary phase specifying unit, if the normalization encoding block distortion amount calculated by the normalization encoding block distortion calculation unit is small and the encoding block distortion amount calculated by the encoding block distortion amount calculation unit is large.

5. The image processing control device according to claim 3, wherein the control unit increases a degree of reducing the encoding block distortion generated between the pixels of the maximum boundary phase specified by the maximum boundary phase specifying unit, if the normalization encoding block distortion amount calculated by the normalization encoding block distortion calculation unit is large and the encoding block distortion amount calculated by the encoding block distortion amount calculation unit is small.

6. The image processing device according to claim 1, wherein the adjacent pixel difference absolute value phase-based total value calculation unit calculates the adjacent pixel difference absolute value phase-based total values with respect to neighboring pixels in a horizontal direction of the image.

7. The image processing device according to claim 1, wherein the adjacent pixel difference absolute value phase-based total value calculation unit calculates the adjacent pixel difference absolute value phase-based total values with respect to neighboring pixels in a vertical direction of the image.

8. The image processing device according to claim 1, further comprising an image size change unit configured to change an image size of an image, the image size of which is changed after encoding,
wherein the adjacent pixel difference absolute value phase-based total value calculation unit calculates the adjacent pixel difference absolute value phase-based total value of the image, the image size of which is changed by the image size change unit.

9. An image processing control method of an image processing control device, comprising:
at an adjacent pixel difference absolute value phase-based total value calculation unit of the image processing control device, calculating adjacent pixel difference absolute value phase-based total values obtained by summing adjacent pixel difference absolute values, which are absolute values of differences in pixel value between adjacent pixels of an image subjected to predetermined image processing, with respect to between all the pixels of the image, every phase representing a location between the pixels of an encoding block when the image is encoded;
at a maximum boundary phase specifying unit of the image processing control device, specifying a maximum boundary phase which is a phase of a maximum value among the adjacent pixel difference absolute value phase-based total values calculated every phase; and
at a control unit of the image processing control device, controlling the image processing so as to reduce encoding block distortion generated between pixels of the specified maximum boundary phase.
